(19) United States
(12) Patent Application Publication
(10) Pub. No.: US 2026/0256555 A1
(43) Pub. Date: Sep. 3, 2026

(54) EXTRA-ORAL IMAGE TAKING DEVICE

(71) Applicant: DENTAL MONITORING, PARIS (FR)

(72) Inventors: Thomas PELLISSARD, PARIS (FR); Cédric LANÇON, VILLERS FARLAY (FR); Louis-Charles ROISIN, PARIS (FR)

(21) Appl. No.: 18/880,098

(22) PCT Filed: Jun. 30, 2023
(86) PCT No.: PCT/EP2023/068111

§ 371 Date: Dec. 30, 2024

(30) Foreign Application Priority Data
Jul. 4, 2022 (FR) FR2206750

(51) Int. Cl. A61C 9/00

(52) U.S. Cl. CPC A61C 9/0053; A61C 9/0093

(57) ABSTRACT

Disclosed is an extra-oral image taking device comprising:—a support having a hollow support portion,—a mouthpiece borne by the hollow support portion, the mouthpiece defining a mouthpiece opening, the area of the surface covered by the mouthpiece opening being greater than 2 cm²,—an image acquisition apparatus for taking images through the mouthpiece opening, the hollow support portion delimiting an image taking chamber, the image acquisition apparatus being at least partially, preferably entirely, accommodated in the image taking chamber.

The present invention concerns a device for taking images of dental arches.

It is known, for example from WO 2016/066651A1 , to monitor the progress of a patient's orthodontic treatment by comparing the evolution of an orthodontic model generated from images of the patient's lower and upper dental arches acquired prior to the implementation of the orthodontic treatment with images of said arches acquired during the course of the orthodontic treatment.

Images of the dental arches can be acquired using an image taking device equipped with an image acquisition apparatus and a mouthpiece.

Examples of such image taking devices are described in EP 3 391 810 A1 and WO 2022/008533A1 , which show a cell phone equipped with a camera for taking images of dental arches.

However, a cell phone is bulky and can make it difficult to handle these devices, once the mouthpiece has been inserted into the user's mouth.

There is therefore an ongoing need for a new device for taking extra-oral images of dental arches, especially one that is easy to handle.

The invention relates to a device for extra-oral image taking, comprising
a support comprising a hollow support portion,
a mouthpiece borne by the hollow support portion, the mouthpiece defining a mouthpiece opening, and
an image acquisition apparatus for taking images through the mouthpiece opening.

According to a first aspect of the invention, the area of the surface covered by the mouthpiece opening is greater than 2 cm², and the hollow support portion delimits an image taking chamber, the image acquisition apparatus being at least partially, preferably entirely, accommodated in the image taking chamber.

The device according to the first aspect of the invention is thus easy to handle. As the acquisition apparatus is located at least partially in the image taking chamber, it has little or no effect on the handling of the device during image-taking.

According to a second aspect of the invention, the image acquisition apparatus is preferably attached to the support, preferably to the hollow support portion, and comprises a camera, preferably less than 15 cm, better still less than 7 cm, from the mouthpiece.

As will become clearer in the following description, the device according to the second aspect of the invention is advantageously compact, resulting in particular from the short distance separating the image acquisition apparatus from the mouthpiece, which makes it easy to handle.

The device according to the first aspect of the invention preferably has the features of the device according to the second aspect of the invention and vice versa.

Furthermore, the device according to the invention, and in particular according to any of its first and second aspects, may comprise one or more of the optional features described below.

The mouthpiece defines an upper bearing surface and/or a lower bearing surface for contacting and displacing the user's lower lip and/or upper lip, respectively, in the device's service position in which the mouthpiece is inserted into the user's mouth. The distance between the mouthpiece and the image acquisition apparatus is the smallest distance between the lower bearing surface of the mouthpiece and the image acquisition apparatus, or between the upper bearing surface of the mouthpiece and the camera.

“Extra-oral” images are acquired using the device according to the invention, which in an operating configuration in which the mouthpiece is inserted into the user's mouth, is such that the image acquisition apparatus is outside the user's oral cavity. An extra-oral image is acquired from a position distant from the oral cavity.

The image acquisition apparatus is preferably spaced at least 6 cm from the mouthpiece. It is preferably spaced between 2.5 cm and 6 cm from the mouthpiece. This increases the resolution of images acquired by the image acquisition apparatus. Furthermore, when the device is positioned for occlusal image-taking, the risk of it colliding with the user's face, such as the nose, is reduced.

The volume occupied by the image acquisition apparatus is preferably less than 40 cm³, more preferably less than 20 cm³, or even less than 10 cm³.

The mass of the image acquisition apparatus is preferably less than 50 g, and more preferably less than or equal to 30 g.

Preferably, the length of the hollow support portion, measured along the longitudinal axis, is less than 10 cm.

The image acquisition apparatus may be devoid of a display and/or telephone communication module. Preferably, the image acquisition apparatus is not embedded in a cell phone. Preferably, the image acquisition apparatus is different from a cell phone.

The image acquisition apparatus comprises, or consists of, at least one camera for taking images through the mouthpiece opening.

The camera may have a focal length of between 25 mm and 90 mm, preferably between 30 mm and 45 mm.

Preferably, the camera's focal length is fixed, making it possible to advantageously use a compact camera. In one variant, the camera may comprise an autofocus system that varies the focal length.

The camera may extend along an axis parallel to, or even coincident with, the longitudinal axis of the support. The line of sight of the camera may be parallel to, or even coincident with, the longitudinal axis of the support.

In one variant, the image acquisition apparatus may comprise, or even consist of, at least two cameras. The cameras can be arranged along different lines of sight, and to each acquire different views of the same dental scene. The image acquisition apparatus can thus provide a stereoscopic view of the dental scene. The cameras may have the same focal length.

The image acquisition apparatus may be fixed relative to the mouthpiece. Thus, the device enables images to be taken under similar conditions at different times during the orthodontic process. Similar acquisition conditions comprise the position and relative orientation of the image acquisition apparatus with respect to the patient's teeth. In one embodiment, the image acquisition apparatus can be movable relative to the mouthpiece.

The image taking apparatus may comprise a connection module for transferring images acquired by the image acquisition apparatus, for example to a digital image storage unit, such as a Flash memory. In one embodiment, the image taking device may comprise the image storage unit.

The connection module can be fixed to the support, in particular to the hollow support portion, for example glued to a wall of the support.

Alternatively, the image acquisition apparatus may comprise the connection module. In particular, the image acquisition apparatus may comprise a housing in which the camera(s) and the connection module are housed. The camera(s) and connection module can be attached to each other.

The connection module may comprise a connection socket for a data transfer cable, for example a USB® cable, or such a data transfer cable, or is a remote data transfer module, for example implementing the Wifi® or Bluetooth® data transfer protocol.

For example, the connection module is a connection socket for a data transfer cable, such as a USB® socket. The support may extend along a longitudinal axis and comprise an opening, for example an axial or transverse one, through which the connection socket opens out of the support, in particular out of the hollow support portion.

The hollow support portion can extend longitudinally and the mouthpiece can extend the hollow support portion.

The hollow support portion can be made of cardboard or, preferably, a thermoplastic material. The device is shaped so that, in the operating configuration, the hollow support portion is at least partly, preferably entirely, outside of the user's mouth.

The hollow support portion can be grippable. It may comprise reliefs and/or recesses shaped to ensure optimal gripping of the device.

The hollow support portion may comprise a bottom wall, for example solid, longitudinally opposite the mouthpiece opening. The image acquisition apparatus may be in contact with, in particular attached to, the back wall.

The hollow support portion can take the form of a longitudinally extending housing opening substantially outwards only through the mouthpiece opening, and optionally through a ventilation opening, for example longitudinally opposite the mouthpiece opening. The ventilation opening facilitates the evacuation of humid air exhaled by the user, in the operating configuration of the device. The hollow support portion can be substantially cylindrical in shape.

The hollow support portion can have a preferably opaque wall that delimits the image taking chamber. It can be substantially tubular.

In one variant, the support further comprises a grippable support portion which is mounted on the hollow support portion, so that the device can be handled by gripping the grippable support portion.

The grippable support portion can extend longitudinally and protrude transversely from the hollow support portion.

Preferably, the hollow support portion is arranged between the mouthpiece and the grippable support portion.

The hollow support portion can be attached, for example removably, to the grippable support portion. Preferably, the grippable support portion and the hollow support portion form a monolithic assembly.

The grippable support portion can define a cavity and include a cover closing the cavity. The device may comprise an electronic board comprising a printed circuit and/or a battery controlling and/or electrically powering the image acquisition apparatus, which are preferably accommodated in the cavity. The cavity can also be made watertight, in particular by means of one or more seals.

Furthermore, the battery may be self-contained. It can be electrically charged by induction, or by a wired connection, such as USB. It can be powered directly by a wired electrical connection to an external power source.

The hollow support portion and/or the grippable support portion can be covered at least in part by a flexible material that facilitates gripping, for example a thermoplastic elastomer known as “TPE”, in particular a thermoplastic rubber known as “TPR”, such as styrene-butadiene-styrene, or a thermoplastic polyurethane known as “TPU”.

The mouthpiece is preferably shaped to move, and preferably curl, the user's upper and lower lips up and down respectively, in an operating configuration of the device in which the mouthpiece is introduced into the mouth of the device user, so as to maximize the dental surface visible to the image acquisition apparatus. “Up” and “down” refer to directions along a vertical axis when the user of the device is standing upright. Preferably, the mouthpiece is shaped so that, when in at least one position of the operating configuration of the image taking device in which the mouthpiece is inserted into the user's mouth, the upper and lower lips are moved, preferably curled, upwards and downwards respectively so that at least the incisors, and preferably at least part of the canines and/or molars, of the upper and lower dental arches respectively are visible to the camera.

The mouthpiece may be a flange, particularly annular or ring-shaped, extending radially outwards from one end of the hollow support portion, and for example transversely to said portion. “Radially outwards” means that the tubular part extends away from the longitudinal axis of the device in a plane transverse to this axis. The flange can be rigid or elastically deformable. In particular, it can be made of a material with a Young's modulus less than or equal to the Young's modulus of the material of the hollow support portion.

Furthermore, the mouthpiece can be integral with the support, in particular with the grippable support portion. In other words, the mouthpiece and the grippable support portion, can be obtained together in the same manufacturing operation. The grippable support portion and the mouthpiece can be produced by molding and/or additive manufacturing.

Alternatively, the mouthpiece can be mounted on the hollow support portion. It can be attached to the hollow support portion. The mouthpiece can be rigidly attached to the hollow support portion. For example, it can be snapped, screwed or glued onto the grippable part. Alternatively, the mouthpiece can be removably mounted on the hollow support portion, for example by magnetic coupling, or by means of a hook-and-loop fastener, or by form-fit between the hollow support portion, and the mouthpiece. Advantageously, it is possible to mount different grippable mouthpieces of various sizes on the support, in particular on the hollow support portion, and thus choose the mouthpiece best suited to the morphology of each user's mouth.

Preferably, the surface covered by the mouthpiece opening has an area greater than 3 cm², preferably greater than 5 cm², preferably greater than 10 cm², or even greater than 15 cm², for example around 19 cm²; Preferably, it is less than 30 cm², more preferably less than 25 cm² . This area is measured transversely to the longitudinal axis. The contour of the mouthpiece opening can be delimited by observing the image taking device along the longitudinal axis, from a position opposite the image acquisition apparatus along the longitudinal axis.

The device may comprise a mirror attached to the support so that the image acquisition apparatus acquires a composite image comprising a direct image of the mouthpiece opening and an image of the mouthpiece opening reflected by the mirror. Thus, in the service configuration, the image acquisition apparatus sees a composite image comprising a direct image of the teeth observed directly through the mouthpiece opening and a reflected image of the teeth reflected by the mirror.

Alternatively, the device may comprise a light source arranged to shine through the mouthpiece opening.

The light source may comprise at least one lamp, in particular a light-emitting diode lamp, and/or a flash unit.

The light source is preferably located in the image taking chamber.

The device may comprise a control module to monitor the properties of the radiation emitted by the light source, in particular as a function of the light radiation received through the mouthpiece opening. For example, the control module can be configured so that more than 50%, more than 90% or even substantially 100% of the radiation received by the mouthpiece opening comes from the light source.

In particular, the device may comprise a plurality of light sources and a plurality of cameras, each light source being arranged to illuminate the optical field of a corresponding camera. The light source(s) can be accommodated in the housing.

In order to determine the color and/or translucency of the user's teeth, the device may comprise a colorimetric target and/or a translucency target, respectively, attached to the support, with the image acquisition apparatus viewing said target(s).

The device may comprise a control module for controlling image acquisition.

The control module may comprise an actuator and be configured to trigger image acquisition by the acquisition apparatus following actuation of the actuator. For example, the actuator is electrically connected to the acquisition apparatus.

The actuator is, for example, a pushbutton. It can be carried by the support.

The control module may comprise a memory storing a computer program and a processor for executing the computer program, the computer program comprising instructions for guiding the user, for example by issuing a voice message, to position the device relative to the patient's teeth to a predetermined acquisition position and/or orientation, and optionally, specifying to the user the number of images to be acquired.

The control module can be housed in the image taking chamber.

Alternatively, the image taking device can communicate, for example via a wireless link or a cable, with a control device, such as a cell phone or personal computer, incorporating a control module as described above.

In addition, the image taking device may further comprise one or more additional cameras which, in at least one configuration of the device, can be positioned in the user's oral cavity to acquire at least one intra-oral image of the lower dental arch and/or the upper dental arch, facilitating, for example, the taking of images of the lingual surfaces of the teeth, interdental spaces, caries control, or palate control. In particular, the image taking device can comprise a telescopic arm that extends between a folded configuration and at least one unfolded configuration, with the additional camera mounted on the telescopic arm. Preferably, in the folded configuration, the additional camera(s) are fully accommodated in the bracket. Preferably, in the operating configuration of the image taking device and in the unfolded position of the arm, the additional camera(s) are positioned in the user's oral cavity to acquire at least one intra-oral view of the lower dental arch and/or the upper dental arch.

Further features and advantages of the invention will become apparent from the following detailed description and from the appended drawing, wherein:

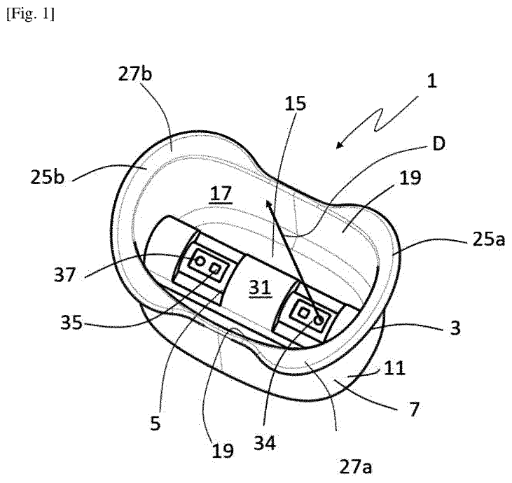

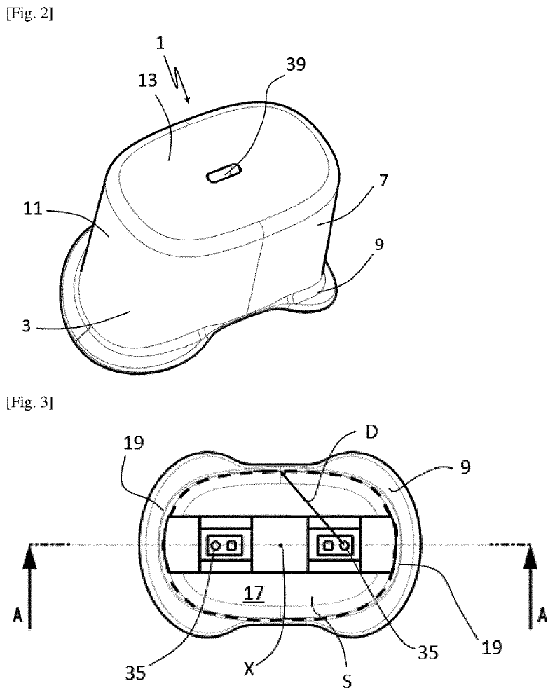

FIG. 1 and FIG. 2 are perspective views from different vantage points and lines of sight of a first example of an extra-oral image taking device according to the invention,

FIG. 3 is a view along the longitudinal axis of the device shown in FIG. 1,

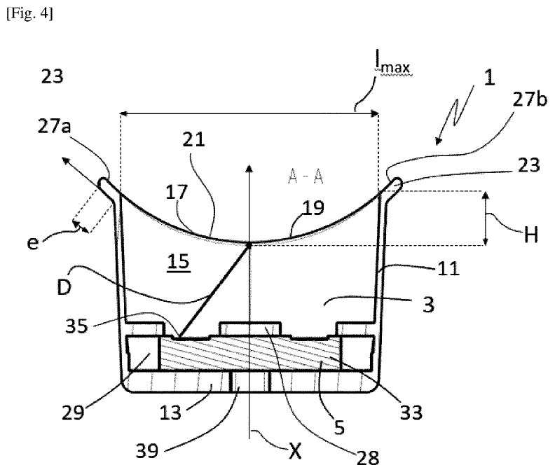

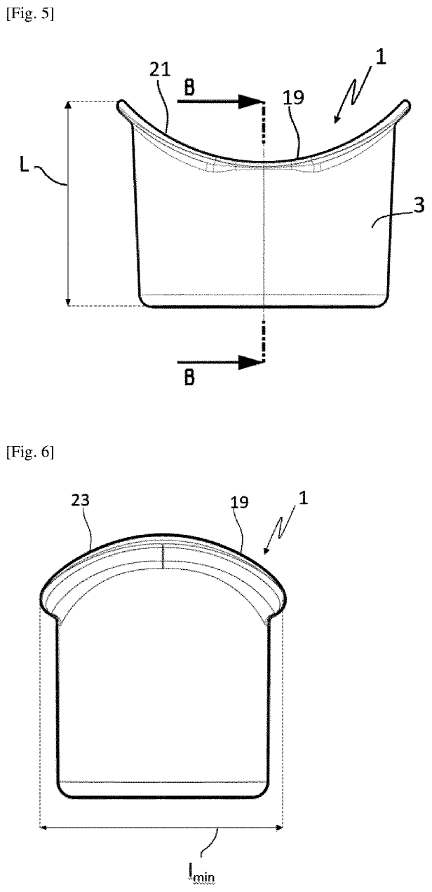

FIG. 4 is a sectional view along the plane (A-A) shown in FIG. 2, FIG. 5 and

FIG. 6 are a side view, along axes normal to the longitudinal axis, of the device,

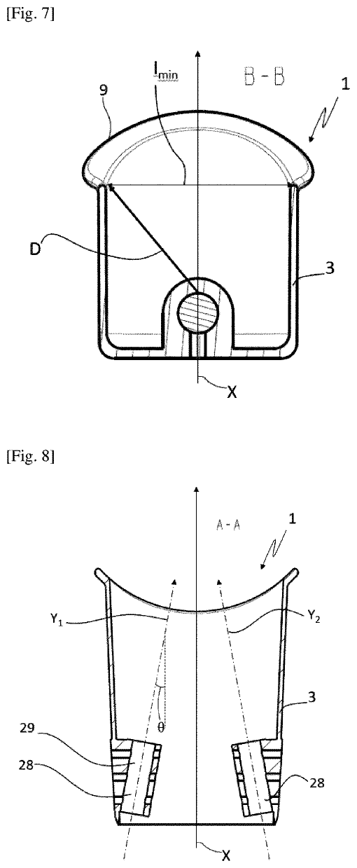

FIG. 7 is a sectional view along the plane (B-B) shown in FIG. 5,

FIG. 8 is a cross-sectional view along a longitudinal median plane of a second example of a device support according to the invention,

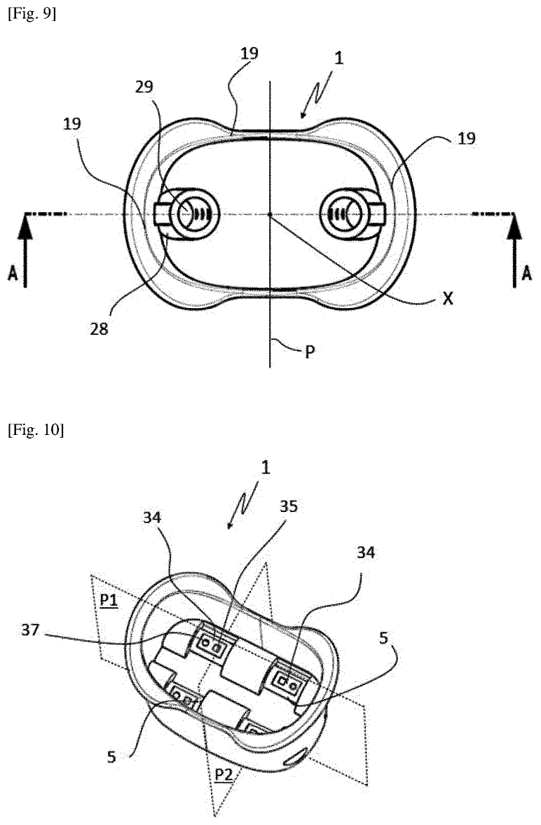

FIG. 9 is a view along the longitudinal axis and through the mouthpiece opening of the support shown in FIG. 8,

FIG. 10 is a perspective view of a third example of a device for taking extra-oral images according to the invention,

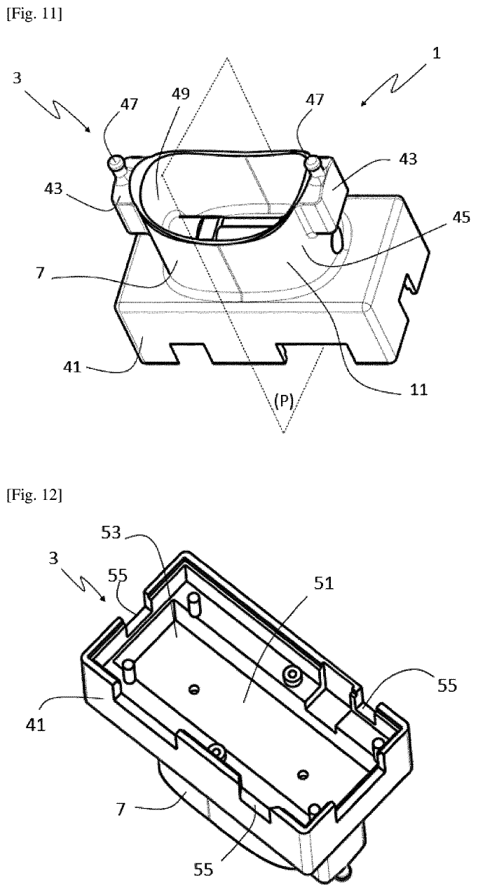

FIG. 11 and FIG. 12 are perspective views from different vantage points and lines of sight of a fourth example of an extra-oral image taking device according to the invention,

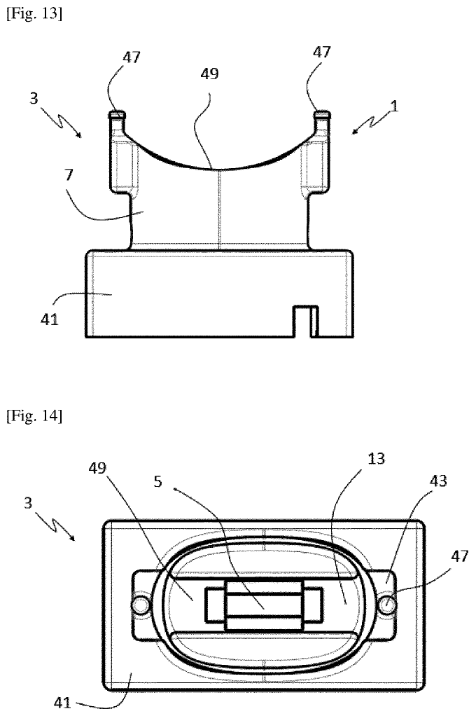

FIG. 13 and FIG. 14 are side and top views of the fourth example.

A first example of a device 1 for taking extra-oral images according to the invention is shown in FIGS. 1 to 7.

The device comprises a support 3 and an image acquisition apparatus 5.

The support 3 comprises a hollow support portion 7. The device further comprises a mouthpiece 9.

The hollow support portion 7 has a generally elongated shape extending along a longitudinal axis X. It comprises a hollow tubular part 11 and a bottom wall 13 which closes off one longitudinal end of the tubular part. The tubular part 11 and the bottom wall 13 delimit an image taking chamber 15 wherein the image acquisition apparatus 5 is housed.

The bottom wall 13 can be solid or have ventilation openings running through it, for example in the form of cylindrical holes and/or grooves. In one embodiment, the grippable support portion 7 may be free of such a bottom wall.

At least part of the tubular part 11, or even the entire tubular part as shown, preferably extends parallel to the longitudinal axis X, to facilitate the holding and handling of the hollow support portion, which is thus additionally grippable.

The tubular section 11 has at least one cross-section S transverse to the longitudinal axis X with a substantially oblong overall shape, delimited by the dotted outline in FIG. 3. Such a shape of the hollow support portion facilitates the gripping of the support and also substantially corresponds to the shape of the contour of the access opening to a user's oral cavity, which is delimited by the lower and upper lips when the user spreads their lower and upper jaws apart.

The tubular part 11 opens out at another end, longitudinally opposite the bottom wall, into a mouthpiece opening 17.

The contour 19 of the mouthpiece opening is shaped like a saddle. In other words, when viewed from two perpendicular directions which are themselves orthogonal to the longitudinal direction and as shown in FIGS. 5 and 6, the contour 19 of the mouthpiece opening 17 has two opposing convex portions 21 connected by opposing concave portions 23.

The shape of the mouthpiece opening is preferably adapted to the general shape of the user's dental arches.

Preferably, when viewed along the longitudinal axis, the maximum width Iₘₐₓ of the mouthpiece opening is between 60 mm and 70 mm and the minimum width 1 min of the mouthpiece opening is between 28 mm and 40 mm. The “maximum width” and “minimum width” are respectively the diameter of the smallest circle circumscribing the contour of the mouthpiece opening and the diameter of the largest small circle inscribed in the contour of the mouthpiece opening 17. Preferably, when viewed along an axis perpendicular to the longitudinal axis, the height H of the contour of the mouthpiece opening, measured along the longitudinal axis, is between 8 mm and 14 mm.

The mouthpiece 9 is attached to the hollow support portion 7. In the example shown, it is made of the same material as the hollow support portion. Other shapes can be envisaged, for example, with the mouthpiece made of a material other than the hollow support portion.

The mouthpiece 9 comprises two rigidly interconnected portions 25a-b, preferably symmetrical to each other with respect to a median plane, which respectively define an inner bearing surface 27a and an outer bearing surface 27b, for contacting and displacing the user's lower lip and/or upper lip respectively in the device's operating position in which the mouthpiece is introduced into the user's mouth.

The mouthpiece 9 is a flange that projects radially outwards from the tubular part 11, from the longitudinal end of the tubular part opposite the bottom wall 13.

The flange is ring-shaped and deformed into a saddle. The contour of the flange, viewed along the X axis, is homothetic with the contour of the mouthpiece opening.

The flange can extend a distance e of between 3 mm and 6 mm from the hollow support portion. The distance e is measured, in a section transverse to the longitudinal axis, between the radially outermost end of the bead and the hollow support portion, along an axis T tangent to the flange and passing through the point of intersection between the hollow support portion and the flange.

The image acquisition apparatus 5 can be attached to the support 3. For example, as shown in FIGS. 1, 4 and 7, the support comprises a receptacle 27 which defines a housing 29 of complementary shape to the acquisition apparatus and in which the image acquisition apparatus is received.

The receptacle comprises a receptacle wall 31, for example of hemi-cylindrical shape, which extends transversely between the opposite inner faces of the tubular part and longitudinally from the bottom wall of the hollow support portion.

In the example shown, the receptacle is made of the same material as the hollow support portion. Alternatively, it can be attached to the hollow support portion.

The image acquisition apparatus comprises a housing 33 and two optical assemblies 34, each including a camera 35 and an LED lamp 37, which are housed entirely within the housing. This number of cameras and lamps is non-limiting. The image acquisition apparatus 5 may additionally comprise a communication module received in the housing for transmitting images taken through the mouthpiece opening 17 by the cameras 35 to a storage unit. For example, the communication module may include a connection socket for a data transfer cable, and the bottom wall 13 may comprise a recess 39 through its thickness for inserting the plug of such a cable and plugging it into the connection socket.

In the example shown, each camera 25 is equidistant from the mouthpiece 9. The cameras are each positioned at a distance D of less than 42 mm from the mouthpiece. Furthermore, the length L of the hollow support portion 7, measured along the longitudinal axis, may be less than 8 cm. This makes the image taking device particularly compact, and thus easier to grip.

In order to take extra-oral images of their dental arches, the user takes hold of the hollow support portion 7 to insert the mouthpiece 9 into their mouth and bring the lower and upper bearing surfaces 27a and 27b into contact with their lower and upper jaw respectively, so as to curl the lower and upper lips respectively.

Extra-oral image-taking and corresponding image acquisition can then be performed.

FIGS. 8 and 9 show a second example of an image taking device according to the invention. This further example differs from the first example shown in FIGS. 1 to 7 in that it comprises two receptacles 27, each shaped to receive an image acquisition apparatus. The receptacles may be integral with the hollow support portion or attached to the hollow support portion.

The receptacles are symmetrical to each other with respect to a median longitudinal plane P of the carrier, which contains the longitudinal axis X.

The receptacles each define tubular housings of respective axes Y1 and Y2 which are inclined to the longitudinal axis X by the same angle θ.

The acquisition apparatuses, not shown, can each comprise an optical assembly.

The optical assemblies can be arranged symmetrically with respect to the longitudinal median plane of the support, for example so as to build a 3D stereoscopic model representing the common scene seen by the cameras through the mouthpiece opening. The cameras in each optical assembly have axes Y₁ and Y₂ respectively. The light sources in each optical assembly comprise LEDs, for example, distributed around the camera's perimeter, evenly distributed around the respective Y₁ and Y₂ axes.

The example shown in FIG. 10 differs from the example shown in FIG. 1 in that it comprises two image acquisition apparatuses 5 in contact with the bottom wall 13 of the hollow support portion 7 and arranged symmetrically to each other with respect to a first median longitudinal plane PL. Each image acquisition apparatus 5 comprises two optical assemblies 34 each comprising a camera 35 and an LED lamp 37.

The optical assemblies 34 are arranged symmetrically with respect to a second median longitudinal plane P2 of the device, orthogonal to the first median longitudinal plane. The cameras' lines of sight may be parallel to each other, or at an angle to each other, as in the second example shown in FIG. 8, and may intersect at the same point.

FIGS. 11 to 14 show a fourth example of a device 1 according to the invention, which differs from the devices shown in FIGS. 1 to 10 in particular in that the support 3 comprises a hollow support portion 7 and a grippable support portion 41 which extends the hollow support portion 7.

The support portion 7 also has beads 43 which are supported by the outer wall 45 of the tubular part 11. The beads 43 are arranged symmetrically with respect to a longitudinal median plane P of the hollow support portion 7. They are each surmounted longitudinally by a head 47 onto which a mouthpiece not shown, as described for example in application WO 2022/008533, can be snapped or fitted by form-fit.

The hollow support portion 7 is in the form of a tubular housing opening into a support opening 49, and has a bottom wall 13 opposite the support opening 49. The bottom wall 13 separates the hollow support portion 7 from the grippable support portion 4L An acquisition apparatus 5 is arranged in contact with the bottom wall and comprises an optical assembly with a camera for viewing a scene through the support opening 49 and the mouthpiece opening, not shown.

The hollow support portion 7 is located between the mouthpiece and the grippable portion 41.

The grippable support portion 41 may have a generally parallelepiped shape, with length, width and height selected for easy gripping. However, any other suitable form can be considered. The grippable support portion 41 extends longitudinally, away from the mouthpiece, from the bottom wall 13. It also protrudes laterally from the hollow support portion 7. The grippable support portion 41 may be hollow and comprise a cavity 51 accessible through an access opening 53 opposite the mouthpiece opening.

The access opening 53 can be surmounted by a cover, not shown, to close off the cavity 51 in order to protect components that may be housed in the cavity, to conceal them from the user's view, and to facilitate gripping of the device. An electronic board, not shown, for controlling and/or monitoring the image acquisition apparatus can be housed in the cavity, together with a battery for electrically powering the electronic board and the image acquisition apparatus.

In addition, side windows 55 are provided in the side wall 57 of the grippable support portion 41, for example to allow a data transfer and/or battery charging cable to pass through the side wall into the cavity, or to provide a switch to turn the device on and/or off.

Of course, the invention is not limited to the examples described here, which are illustrative and non-limiting.

For example, in a variant of the device shown in FIGS. 11 and 14, the support may comprise a mouthpiece being a flange integral with the tubular part 11, as shown in FIG. 1.

1. A device for extra-oral image taking, comprising
a support comprising a hollow support portion,
a mouthpiece carried by the hollow support portion, the mouthpiece defining a mouthpiece opening, the surface area covered by the mouthpiece opening being greater than 2 cm²,
an image acquisition apparatus for taking images through the mouthpiece opening, the hollow support portion delimiting an image taking chamber, the image acquisition apparatus being at least partially, preferably entirely, housed in the image taking chamber,
the support further comprising a grippable support portion which is mounted on the hollow support portion, the hollow support portion being removably secured to the grippable support portion.

2. The device according to claim 1, the volume occupied by the image acquisition apparatus being less than 40 cm³.

3. The device according to claim 1, the image acquisition apparatus being attached to the support, preferably to the hollow support portion, and comprising a camera less than 15 cm, preferably less than 7 cm, away from the mouthpiece.

4. The device according to claim 1, with the camera having a focal length of between 25 mm and 90 mm, preferably between 30 mm and 45 mm.

5. The device according to claim 1, the image acquisition apparatus being spaced less than 6 cm, preferably between 2.5 cm and 6 cm, from the mouthpiece.

6. The device according to claim 1, comprising a connection module for transferring images acquired by the image acquisition apparatus, preferably comprising a connection socket for a data transfer cable, for example a USB® cable, or such a data transfer cable, or being a remote data transfer module, for example implementing the Wifi® or Bluetooth® data transfer protocol.

7. The device according to claim 1, the image acquisition apparatus comprising, or even consisting of, at least two cameras, preferably arranged along different lines of sight, and each for acquiring different views of the same dental scene.

8. The device according to claim 1, the hollow support portion extending longitudinally and the mouthpiece extending the hollow support portion.

9. The device according to claim 1, the mouthpiece being a flange, in particular annular or in the form of part of a ring, extending radially outwards from one end of the hollow support portion.

10. The device according to claim 8, the mouthpiece being integral with the hollow support portion.

11. The device according to claim 1, the hollow support portion being arranged between the mouthpiece and the grippable support portion.

12. The device according to claim 1, comprising a control module for controlling the acquisition of images, preferably comprising a memory storing a computer program and a processor for executing the computer program, the computer program comprising instructions for guiding the user, for example by issuing a voice message, to position the device relative to the patient's teeth to a predetermined acquisition position and/or orientation.

13. The device according to claim 1, the grippable support portion defining a cavity and comprising a cover closing the cavity.

14. The device according to claim 1, comprising an electronic board with a printed circuit and/or a battery controlling and/or electrically powering the image acquisition apparatus.

15. The device according to claim 13, with the electronic board and/or battery housed in the cavity.

16. The device according to claim 13, the cavity being made watertight, in particular by means of one or more seals.
